(19) United States
(12) Patent Application Publication
(10) Pub. No.: US 2007/0137079 A1
(43) Pub. Date: Jun. 21, 2007

(54) Systems and methods to maintain confidentiality of posted or written information

(76) Inventor: Mark S. McNeil, Seattle, WA (US)

Correspondence Address: Kirkpatrick & Lockhart Preston Gates Ellis LLP, 1735 NEW YORK AVENUE, NW, SUITE 500, WASHINGTON, DC, 20006, US

(21) Appl. No.: 11/311,168

(22) Filed: Dec. 20, 2005

(51) Int. Cl. G09F 15/00

(52) U.S. Cl. 40/606.18

(57) ABSTRACT

Disclosed herein are methods and systems to maintain the confidentiality of posted or written information while at the same time providing a visual display in the place of the posted or written information. The presently disclosed methods and systems maintain the confidentiality of posted or written information while providing a visual display by providing a reversible board having a first side adapted to accept information and a second side with a visual display wherein when information on the first side should be concealed, only the visual display on the second side is viewable.

### FIELD OF THE INVENTION

The present invention provides systems and methods to maintain the confidentiality of posted or written information. More specifically, the present invention provides systems and methods to maintain the confidentiality of posted or written information by providing a reversible writing surface or board with one side adapted to accept written or posted information and the second side adapted to display art work.

### BACKGROUND OF THE INVENTION

In many situations, it is useful to have an area where information can be written or posted, for example, on a surface or a board (hereinafter “board”). Often times, it is desirable for the written or posted information to remain on the board for a specified or unspecified period of time, for example, between meetings or over a semester. During the time when it is desirable to maintain the written or posted information, however, there are also often times when it would be beneficial to maintain the information in its original format, but conceal the information from individuals arriving at the location where it is found. For instance, in a conference room in an office setting, notes may be taken on a board, such as a whiteboard or a chalkboard, during a meeting. If the meeting adjourns for a period of time, for example over lunch or overnight, but will resume at a later time, the meeting participants may want to save the notes taken during the first phase of the meeting. At the same time, these meeting participants may not want other non-meeting participants to view the information during the meeting's hiatus.

In another situation, a board, such as a bulletin board in a public setting, such as a university commons area, may be available for generalized postings. In most situations, it is desirable to have the contents of the postings viewable by visitors to the area. In other situations, however, it may be beneficial for the postings to be concealed from visitors for a period of time. For example, a university may want to tidy the appearance of a commons area for a graduation ceremony or reception occurring in the area.

One approach to providing a board for writings or postings that may later be concealed is to close and lock the area where the information is found. This approach, however, is often not practical or desirable. For instance, in a conference room setting, if information is left on the board over night, the room must be cleaned by janitorial crews. Further, in many circumstances, a meeting with a different group of participants may need to occur in the conference room before the original meeting reconvenes or the written or posted information is otherwise documented. Likewise, and as stated earlier, in a university setting or other public common area, closing and locking an area where a board is found may not be a viable option.

A second approach to maintaining the confidentiality of written or posted information on a board that is left in a generally accessible room or area is to develop wall panels that may slide in front of the information, as, for example, disclosed, in Pomish, et al., U.S. Pat. No. 6,018,915 (the “'915 patent”). The '915 patent relates to a moveable panel with a locking mechanism that can be slid in front of information in a “privacy position” when information should not be accessible and can be retracted into a “non-privacy position” when the information should be viewable.

While the system shown in the '915 patent and other similar systems (such as removable writing or posting panels) exist, these systems do not address the fact that wall space for art and other visually pleasing objects is at a minimum in conference rooms and other public settings. For example, while the moveable panels of the '915 patent may conceal information, the panels do not service the aesthetics of the room when arranged in the “privacy position.” Likewise, removable panels leave only bare wall space when taken down to prevent the unwanted dissemination of information. Therefore, a need exists for systems and methods that allow for information to be maintained on a board but not disclosed in an area that may be visited by individuals who should not view the information while also providing an aesthetically pleasing alternative to moveable or removable panels.

### SUMMARY OF THE INVENTION

The present invention solves the above mentioned problems with concealing but maintaining information by providing reversible wall mounted writing or posting boards. These reversible wall mounted writing or posting boards have one side adapted for writing or posting, while the second side is adapted to include visual art work. Thus, during a meeting in a conference room or during a “regular day” in a university commons area, the writing or posting side of the board can be exposed. When the conference room meeting is not in session or the university is hosting a special event in a commons area, however, the writing or posting board can be reversed to display art work. In this manner, information is maintained yet concealed, and the room becomes decorated, rather than being left with a bare panel or wall.

In one embodiment of the present invention the invention includes methods to conceal yet maintain information while providing a visual display. In one embodiment of the methods of the present invention, the method comprises maintaining yet concealing information by providing a reversible board having a first side and a second side wherein only one side of the reversible board is viewable at a time and wherein the first side is adapted to accept information and the second side comprises a visual display and wherein when information is maintained yet concealed, the visual display on the second side is viewable.

In another embodiment of the methods of the present invention, the reversible board is mounted onto or hung on a flat surface. In another embodiment of the methods of the present invention, the flat surface is selected from the group consisting of a wall, a door, a cabinet, an appliance, a ceiling and a floor. In another embodiment of the methods of the present invention, the wall is found in a location selected from the group consisting of a conference room, a common area, an office, a kitchen, a bedroom, a bathroom, a classroom, and a lecture hall.

In another embodiment of the methods of the present invention, the visual display is selected from the group consisting of a painting, a print, a poster, a mirror, a logo, a photograph, a menu, an LCD screen, etc. When an LCD screen or other similar device is used, the art work can be programmed with changeable graphics, text and/or colors.

In another embodiment of the methods of the present invention, the first side of the reversible board comprises one or more of the group selected from a whiteboard, a chalkboard, a cork board, and a bulletin board.

In another embodiment of the methods of the present invention, the reversible board can be locked into a position wherein the second side and the visual display is viewable and the first side is concealed.

In another embodiment of the methods of the present invention, the first side of the reversible board further comprises a lip extending outwardly from the front surface of the first side around the perimeter of the front surface. In another embodiment of the methods of the present invention, the second side of the reversible board also further comprises a lip extending outwardly from the front surface of the second side around the perimeter of the front surface.

The present invention also includes systems to conceal yet maintain information while providing a visual display. In one embodiment of the systems of the present invention, the system comprises a reversible board having a first side and a second side, wherein the first side is adapted to accept information and the second side comprises a visual display and wherein the system is mounted onto or hung on a flat surface.

In another embodiment of the systems of the present invention, the flat surface is selected from the group consisting of a wall, a door, a cabinet, an appliance a floor and a ceiling. In another embodiment of the systems of the present invention, the wall is found in a location selected from the group consisting of a conference room, a common area, an office, a kitchen, a bedroom, a classroom and a lecture hall.

In another embodiment of the systems of the present invention, the visual display is selected from the group consisting of a painting, a print, a poster, a mirror, a logo, a photograph, a menu an LCD screen, etc. When an LCD screen or other similar device is used, the art work can be programmed with changeable graphics, text and/or colors.

In another embodiment of the systems of the present invention, the first side of the reversible board comprises one or more of the group selected from a whiteboard, a chalkboard, a cork board, and a bulletin board.

In another embodiment of the systems of the present invention, the reversible board can be locked into a position wherein the second side and visual display is viewable and the first side is concealed.

In another embodiment of the systems of the present invention, the first side of the reversible board further comprises a lip extending outwardly from the front surface of the first side around the perimeter of the front surface. In another embodiment of the systems of the present invention, the second side of the reversible board also further comprises a lip extending outwardly from the front surface of the second side around the perimeter of the front surface.

### BRIEF DESCRIPTION OF FIGURES

FIG. 1A depicts a meeting in a conference room where notes are taken on a reversible board of the present invention.

FIG. 1B depicts the conference room during an alternate meeting where the previously taken notes are concealed and art work is displayed.

FIG. 1C depicts the conference room during overnight cleaning by a janitorial crew.

FIG. 1D depicts the original meeting depicted in FIG. 1A resuming.

FIG. 2A depicts a university commons area with a board for various postings.

FIG. 2B depicts the same university commons area during an event on campus when it is appropriate to conceal the postings and display a university logo or other art work instead.

FIG. 2C depicts a university commons area once the more daily activities of campus life have resumed.

### DETAILED DESCRIPTION OF FIGURES

The phrase “conference room” means any room in a non-residential setting where people gather for a common purpose. The common purpose can be, without limitation, to attend a meeting, a party, a teleconference, a videoconference, a class, a lecture, or a protest.

The phrase “common area” means an area that is generally accessible to a specified group of people or to the public for various purposes. For example, a common area in a university setting can include, without limitation, a gathering location in dormitories for resident students, the student union and the lobbies of individual campus buildings. In a hotel setting, a common area can include, without limitation, the lobby, a swimming pool area, a restaurant, a bar and a gym. In addition, elevators in various settings can be considered “common areas.” A common area can also include areas of malls or shopping centers not rented or leased by individual stores.

The phrase “visual display” means any marking placed on the second side of the board of the present invention that prevents the second side of the board from being a bare panel. The visual display can be purely ornamental and consist of a painting, print, poster, and/or a photograph. The visual display also can convey information. For example, the visual display could display a logo, a political message, a safety message, and/or an informational message. In one embodiment the visual display can be provided on an LCD screen, etc. When an LCD screen or other similar device is used, the art work can be programmed with changeable graphics, text and/or colors.

The phrases “front surface of the first side” and “front surface of the second side” refer to the surface of the first or second side of the reversible board of the present invention when the particular side is viewable to individuals within a room or in a common area.

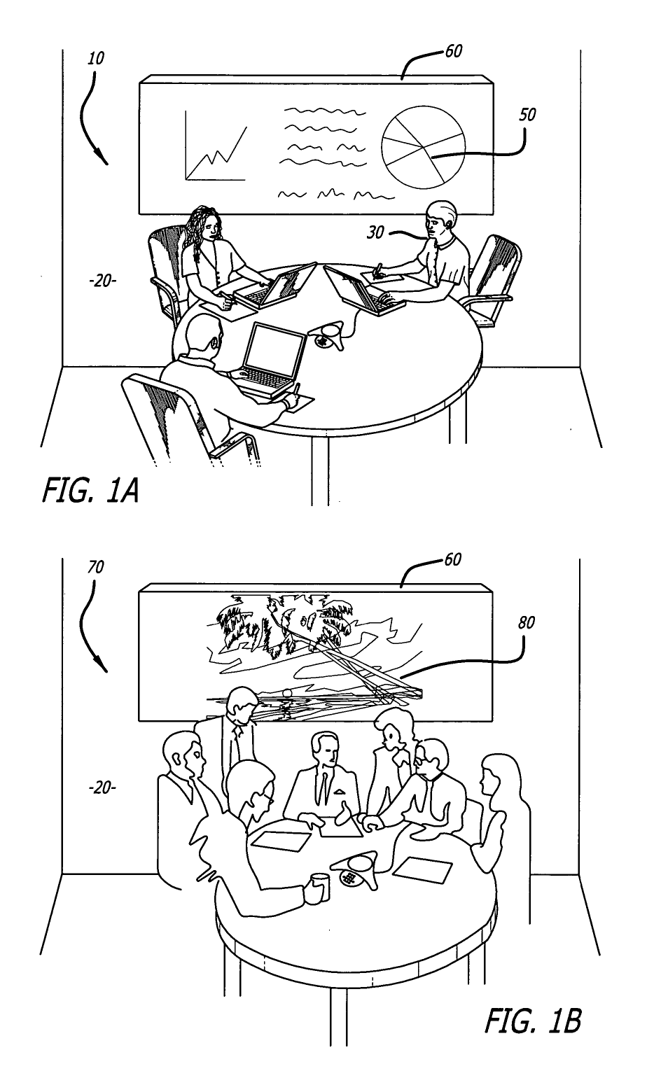

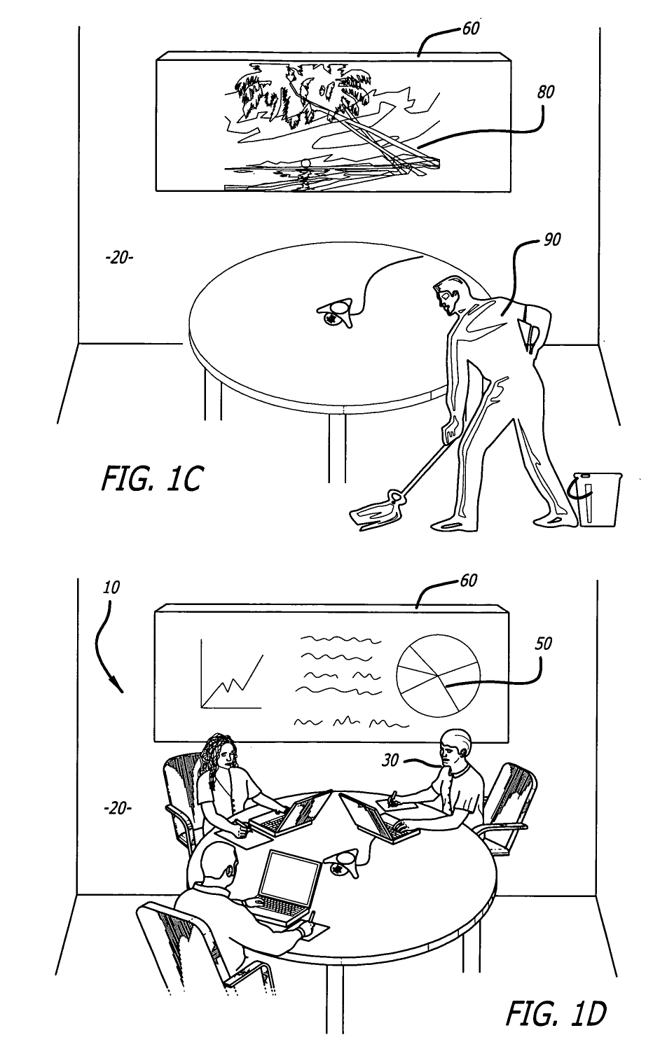

Referring to the FIGS., FIGS. 1A-1D depict the use of the present invention in a conference room setting. In FIG. 1A, a first group 10 has convened for a meeting in a conference room 20. A meeting participant 30 writes information 50 on a reversible board of the present invention 60. After a period of time, the meeting of the first group 10 adjourns for a specified or unspecified time. In FIG. 1B, during the adjournment of the meeting of the first group 10, a second group 70 uses the same conference room 20 to conduct another meeting. During this meeting, the reversible board of the present invention 60 has been reversed to conceal the information 50 of the first meeting and to provide a visual display 80.

In FIG. 1C, the information 50 on the reversible board of the present invention 60 is still concealed when a janitorial crew 90 cleans the conference room 20 at night. While the information 50 remains concealed, the visual display 80 is viewable, providing an aesthetic benefit over slideable and/or removable panels.

Finally, in FIG. 1D, the first group 10 has reconvened in the conference room 20 to continue their meeting. At this time (or before given proper authorization), the reversible board of the present invention 60 is reversed to once again display the information 50 contained on the first side of the board. In this manner, information can be maintained yet concealed as appropriate. When the information is concealed, the reversible boards of the present invention provide a visual display that augments the aesthetics of a room.

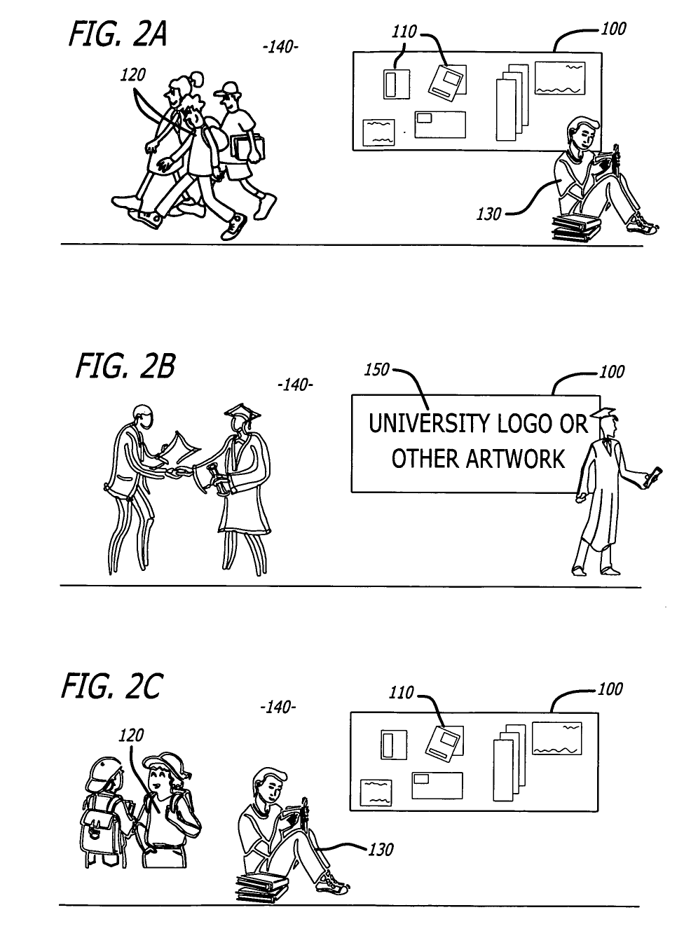

FIGS. 2A-2D depict the use of the reversible boards of the present invention in a university commons area 140. FIG. 2A depicts a reversible posting board 100 of the present invention. In FIG. 2A, individuals or groups have posted information 110 on the reversible posting board 100. Students 120 or other individuals 130 who visit the commons area can view the posted information 110.

While the information 110 posted on the reversible posting board 100 of the present invention should generally be viewable by students 120 or other individuals 130, in some circumstances, the university may want to tidy the appearance of the commons area 140 for a special event. In FIG. 2B, the university has chosen to tidy the appearance of the commons area 140 for a graduation ceremony. In this circumstance, the second side of the reversible posting board 100 of the present invention can display any type of art work, and in one embodiment may display a university logo 150.

When the special event has ended, as in FIG. 2C, the reversible posting board 100 of the present invention can be reversed so that information 110 posted by students 120 or other individuals 130 or groups is again viewable.

The previously described embodiments of the present invention are provided by way of example only and should not be read to limit the applicability or scope of the present invention. For example, and as will be readily apparent to one of skill in the art, the present invention can be adapted to be used in a variety of other circumstances when information is desired to be maintained but concealed for a period of time. In one embodiment, the present invention may consist of a reversible board mounted to a kitchen appliance in a home. Generally, the first side of the board may contain information relating to, for example and without limitation, shopping lists, doctor or other appointments and phone numbers and may be viewable by members of the household. On the day or evening of a gathering within the home, however, the residents of the home may want to conceal this information and instead provide a visual display. In this situation, the board could be reversed thus saving the information on the board, yet concealing it from non-resident guests within the house and providing a visual display within its place.

In another embodiment of the present invention, the reversible board of the present invention could be adapted for use in a bedroom. For example, many children and teenagers often enjoy having bulletin boards with personal mementoes in their bedrooms. Many families often use such children's and teenager's bedrooms as guest rooms for visitors. In this situation, when the child or teenager is staying in their room, the first side of the reversible board containing mementoes could be viewable. When a guest comes, however, the board could be reversed, thus presenting a painting, print or poster more appropriate for an assumably older guest's tastes.

In another embodiment of the present invention, the reversible board of the present invention could be adapted for use in a residential bathroom. For example, a resident of a home could keep a medication schedule posted on the front side of the reversible board. When non-resident guests are expected at the home, however, the board could be reversed to present a decorative visual display and to conceal the posted information.

The reversible boards of the present invention may be mounted or hung onto a flat surface in a number of ways. For example, the reversible boards of the present invention can have a loop or other type of frame hanger attached to the frame for suspension from a wall hook or hook or peg or pegs (hereinafter “wall hook”). In this case, a user removes the frame from the wall hook, turns it around, and rehangs it. Alternatively, a reversible board could be reversed without removing it from its wall hook. The wall hook method of hanging the reversible boards of the present invention also can include a suspension line attached at two points on one edge of the frame by means of suspension loops, tacks or the like. This approach is commonly seen applied to window signs indicating whether a shop is open or closed for business.

Another approach to hanging the reversible boards of the present invention is described in U.S. Pat. No. 5,099,589 to Lai, which is hereby incorporated by reference. In this approach, a reversible display frame is specially formed so that one edge of the frame fits into a wall member designed to suspend the frame from a wall. The display frame may be slid on and off the wall hanger to enable a user to flip the display frame over.

Yet another approach to hanging the reversible boards of the present invention is shown in U.S. Pat. No. 6,775,939 to Juern which is hereby incorporated by reference. In this approach, a user may reverse the side of a display frame by lifting a lower portion of the display frame away from the wall on which it is mounted, rotating the display frame and attached suspension device by means of the pivotal coupling of the wall assembly, and setting the frame back on the wall.

It is to be understood that the present invention is not limited to the particular embodiments, materials, and examples described herein, as these can vary. It also is to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “a reversible board” or “a visual display” is a reference to one or more reversible boards or visual displays and includes equivalents thereof known to those skilled in the art and so forth.

Unless defined otherwise, all technical terms used herein have the same meanings as commonly understood by one of ordinary skill in the art to which this invention belongs. Specific methods, devices, and materials are described, although any methods and materials similar or equivalent to those described herein can be used in the practice or testing of the present invention.

What is claimed is:

1. A method comprising:
maintaining yet concealing information by providing a reversible board having a first side and a second side wherein only one side of said reversible board is viewable at a time and wherein said first side is adapted to accept information and said second side comprises a visual display and wherein when said information is maintained yet concealed, said visual display on said second side is viewable.

2. The method according to claim 1, wherein said reversible board is mounted onto or hung on a flat surface.

3. The method according to claim 2, wherein said flat surface is selected from the group consisting of a wall, a door, a cabinet, an appliance, a ceiling and a floor.

4. The method according to claim 3, wherein said wall is found in a location selected from the group consisting of a conference room, a common area, an office, a kitchen, a bedroom, a bathroom, a classroom and a lecture hall.

5. The method according to claim 1, wherein said visual display is selected from the group consisting of a painting, a print, a poster, a mirror, a logo, a photograph, a menu and a display on an LCD screen.

6. The method according to claim 1, wherein said first side of said reversible board comprises one or more of the group selected from a whiteboard, a chalkboard, a cork board, and a bulletin board.

7. The method according to claim 1, wherein said reversible board can be locked into a position wherein said second side and said visual display is viewable and said first side is concealed.

8. The method according to claim 1, wherein said first side of said reversible board further comprises a lip extending outwardly from the front surface of said first side around the perimeter of said front surface.

9. The method according to claim 8, wherein said second side of said reversible board also further comprises a lip extending outwardly from the front surface of said second side around the perimeter of said front surface.

10. A system comprising
a reversible board having a first side and a second side, wherein said first side is adapted to accept information and said second side comprises a visual display and wherein said system is mounted onto or hung on a flat surface.

11. The system according to claim 10, wherein said flat surface is selected from the group consisting of a wall, a door, a cabinet, an appliance, a ceiling and a floor.

12. The system according to claim 11, wherein said wall is found in a location selected from the group consisting of a conference room, a common area, an office, a kitchen, a bedroom, a classroom and a lecture hall.

13. The system according to claim 10, wherein said visual display is selected from the group consisting of a painting, a print, a poster, a mirror, a logo, a photograph, a menu and a display on an LCD screen.

14. The system according to claim 10, wherein said first side of said reversible board comprises one or more of the group selected from a whiteboard, a chalkboard, a cork board, a bulletin board, and a display on an LCD screen.

15. The system according to claim 10, wherein said board can be locked into a position wherein said second side and said visual display is viewable and said first side is concealed.

16. The system according to claim 10, wherein said first side of said reversible board further comprises a lip extending outwardly from the front surface of said first side around the perimeter of said front surface.

17. The system according to claim 16, wherein said second side of said reversible board also further comprises a lip extending outwardly from the front surface of said second side around the perimeter of said front surface.
